(19) United States
(12) Patent Application Publication
(10) Pub. No.: US 2019/0177006 A1
(43) Pub. Date: Jun. 13, 2019

(54) Airborne Wind Turbine Tower

(71) Applicant: Makani Technologies, Alameda, CA (US)

(72) Inventors: Megan Quick, San Francisco, CA (US); Charles Nordstrom, Berkeley, CA (US)

(21) Appl. No.: 15/840,981

(22) Filed: Dec. 13, 2017

(51) Int. Cl. B64F 3/00; F03D 5/00; F03D 9/32; F03D 13/25; B64C 39/02

(52) U.S. Cl. CPC B64F 3/00; F03D 5/00; F03D 9/32; F05B 2240/93; B64C 39/022; F05B 2240/9121; F03D 13/25

(57) ABSTRACT

An example system includes an aerial vehicle, a tower, a tether, a gimbal assembly coupled to the tower, and a ring or landing surface coupled to the tower. The tether is connected between the gimbal assembly and the aerial vehicle. When the aerial vehicle is not in flight, the aerial vehicle may hang from the tether or park on the landing surface. In some embodiments, the ring or landing surface may support the tether away from the tower to prevent the aerial vehicle from contacting the tower. In some examples, the tower may include a lattice structure and guy wires, in other examples the tower may be tubular, while in other examples the tower may be a buoy.

### BACKGROUND

Unless otherwise indicated herein, the materials described in this section are not prior art to the claims in this application and are not admitted to be prior art by inclusion in this section.

Power generation systems may convert chemical and/or mechanical energy (e.g., kinetic energy) to electrical energy for various applications, such as utility systems. As one example, a wind energy system may convert kinetic wind energy to electrical energy.

The use of wind turbines as a means for harnessing energy has been used for a number of years. Conventional wind turbines typically include large turbine blades positioned atop a tower. The cost of manufacturing, erecting, maintaining, and servicing such wind turbine towers, and wind turbines is significant.

An alternative to the costly wind turbine towers that may be used to harness wind energy is to use an aerial vehicle attached to a ground station with an electrically conductive tether. Such an alternative may be referred to as an Airborne Wind Turbine or AWT.

### SUMMARY

An airborne wind turbine (AWT) system provides a viable way to harness wind energy in applications that were previously unavailable. Various systems and devices for efficiently and safely operating an AWT system are disclosed herein. Example embodiments include a tower and associated structures that place an aerial vehicle of an AWT in a position for more efficient energy generation and simpler storage or parking of the aerial vehicle. Embodiments include aspects that mitigate or prevent damage and increase reliability of components of an AWT system when the aerial vehicle is parked (i.e., not in a flight or power generation mode) or during wind or power failures experienced by the AWT system. Embodiments further include aspects that reduce shear stress experienced by components of the AWT system when the aerial vehicle is in a the power generation flight mode. Moreover, aspects of embodiments described herein also provide for increased safety to the environment surrounding an example AWT system.

In a first aspect, a system is provided. The system includes a tower, a gimbal assembly, a ring, and an aerial vehicle. The tower extends upwards from a surface. In some examples the surface may be a ground surface, while in other examples the surface may be a water surface. The gimbal assembly is coupled to the tower above the surface and is configured to move in multiple axes relative to the tower. Moreover, the ring is also coupled to the tower. The ring is coupled between the surface and the gimbal assembly, and further, the ring extends radially away from the tower a first radial distance. The aerial vehicle is configured for at least a power generating flight mode and a parked mode. Additionally, the aerial vehicle is coupled to the gimbal assembly via a tether. When the aerial vehicle is in power generating flight mode the aerial vehicle flies downwind from the tower. Moreover, when the aerial vehicle is in the parked mode, the aerial vehicle hangs from the tether such that the tether supports the weight of the vehicle. Furthermore, when in the parked mode, the ring is configured to contact the tether at a contact point along the tether.

In a second aspect, another system is provided. The system includes a tower, a gimbal assembly, a first landing surface, and an aerial vehicle. The tower extends upwards from a base surface. Further, the gimbal assembly is coupled to the tower above the base surface. The gimbal assembly is configured to move in multiple axes relative to the tower. Moreover, the first landing surface is also coupled to the tower between the base surface and the gimbal assembly. The first landing surface extends radially from the tower a first radial distance. Additionally, the aerial vehicle is configured for at least a power generating flight mode and a parked mode. The aerial vehicle is coupled to the gimbal assembly via a tether. Further, a linear distance along a length of the tether from the gimbal assembly to a furthest end of the aerial vehicle from the tether is less than an elevation distance of the gimbal assembly above the base surface such that the aerial vehicle is prevented from contacting the base surface. When the aerial vehicle is in power generating flight mode, the aerial vehicle flies downwind from the tower. When the aerial vehicle is in the parked mode, the aerial vehicle rests on the first landing surface.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 depicts an Airborne Wind Turbine (AWT), according to an example embodiment.

FIG. 2 is a simplified block diagram illustrating components of an AWT, according to an example embodiment.

FIG. 3 depicts an aerial vehicle, according to an example embodiment.

FIG. 4 depicts an aerial vehicle coupled to a ground station via a tether, according to an example embodiment.

FIG. 5A depicts an AWT in a first operational mode, according to an example embodiment.

FIG. 5B depicts an AWT in a second operational mode, according to an example embodiment.

FIG. 6A depicts an AWT in a first operational mode, according to an example embodiment.

FIG. 6B depicts an AWT in a second operational mode, according to an example embodiment.

FIG. 7A depicts an AWT in a first operational mode, according to an example embodiment.

FIG. 7B depicts an AWT in a second operational mode, according to an example embodiment.

FIG. 8 depicts an AWT, according to an example embodiment.

FIG. 9 depicts an AWT, according to an example embodiment.

FIG. 10A depicts an AWT in a first operational mode, according to an example embodiment.

FIG. 10B depicts an AWT in a second operational mode, according to an example embodiment.

FIG. 11A depicts an AWT in a first operational mode, according to an example embodiment.

FIG. 11B depicts an AWT in a second operational mode, according to an example embodiment.

### DETAILED DESCRIPTION

Example methods, systems, and devices are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments might include more or less of each element shown in a given Figure. Further, some of the illustrated elements may be combined or omitted. Yet further, an example embodiment may include elements that are not illustrated in the Figures.

### I. OVERVIEW

Illustrative embodiments relate to aerial vehicles, which may be used in a wind energy system, such as an Airborne Wind Turbine (AWT). In particular, illustrative embodiments relate to or take the form systems and devices relating to a tower that serves as a support for a gimbal that is connected to a tether that is connected to an aerial vehicle. Illustrative embodiments further include aspects of the tower that may serve to increase the efficiency of the AWT system as well as prevent damage to components of the system. Such aspects may increase the safety of the use and operation of AWT systems.

By way of background, an AWT may include an aerial vehicle that flies in a closed path, such as a substantially circular path, to convert kinetic wind energy to electrical energy. In an illustrative implementation, the aerial vehicle may be connected to a ground station via a tether. While tethered, the aerial vehicle can: (i) fly at a range of elevations and substantially along the path, and return to the ground or a landing platform, and (ii) transmit electrical energy to the ground station via the tether. In some implementations, the ground station may transmit electricity to the aerial vehicle for take-off and/or landing. The ground station may be located on land or offshore. In some embodiments, the ground station may be fixedly installed, while in other embodiments the ground station may be easily transportable. The ground station may include a tower structure that supports a ground station gimbal (or “gimbal assembly”) that is in turn, connected to the tether.

In an AWT, an aerial vehicle may rest or land in and/or on a ground station, landing platform/surface, or perch when the wind is not conducive to power generation. When the wind is conducive to power generation, such as when a wind speed may be 3.5 meters per second (m/s) at an altitude of 100 meters, the ground station may deploy (or launch) the aerial vehicle. In addition, when the aerial vehicle is deployed and the wind is not conducive to power generation, the aerial vehicle may return to the ground station. When the aerial vehicle as at rest on a landing surface or perched, for example, the aerial vehicle is in a parked mode.

Moreover, in an AWT, an aerial vehicle may be configured for hover flight and crosswind flight. Crosswind flight may be used to travel in a motion, such as a substantially circular motion, and thus may be the primary technique that is used to generate electrical energy (i.e., a power generation flight mode). When the aerial vehicle is flying in crosswind flight the aerial vehicle is considered to be in a crosswind flight mode. Hover flight in turn may be used by the aerial vehicle to prepare and position itself for crosswind flight. In particular, the aerial vehicle could ascend to a location for crosswind flight based at least in part on hover flight. Further, the aerial vehicle could take-off and/or land via hover flight.

In hover flight, a span of a main wing of the aerial vehicle may be oriented substantially parallel to the ground, and one or more propellers of the aerial vehicle may cause the aerial vehicle to hover over the ground. In some implementations, the aerial vehicle may vertically ascend or descend in hover flight. Moreover, in crosswind flight, the aerial vehicle may be oriented, such that the aerial vehicle may be propelled by the wind substantially along a closed path, which as noted above, may convert kinetic wind energy to electrical energy. In some implementations, one or more rotors of the aerial vehicle may generate electrical energy by slowing down the incident wind.

Towers as part of an AWT system described herein may be configured to place the aerial vehicle in a power generating flight mode, such as a crosswind flight mode, that provides efficient energy generation as the aerial vehicle flies along a closed path. As described, when the aerial vehicle is in crosswind flight the airflow acting on the moving aerial vehicle is faster than just the wind experienced by a stationary object. This apparent wind experienced at the aerial vehicle spins rotors of the aerial vehicle, thus generating electricity that is transmitted back to the ground station. Beneficially, a tower, included as part of AWT systems described herein, may position the aerial vehicle such that when the aerial vehicle flies along a closed loop flight path (while in the crosswind flight mode) an inclination angle of a center of the closed loop flight path relative to the wind direction may be reduced. An ideal inclination angle may be zero degrees, e.g. parallel to the wind, in some circumstances.

Among various factors, the angle of the center of the closed path flown by the aerial vehicle with respect to the wind, the inclination angle, affects the efficiency of the energy generation. When the inclination angle between the center of the closed path of the aerial vehicle and the wind is lower, the aerial vehicle is more efficient at using the power of the wind for kinetic energy of the aerial vehicle which in turn allows rotors coupled to the wing to more efficiently generate energy. Put another way, a plane of flight formed by the closed path is perpendicular to a ground surface and/or a wind direction when the inclination angle is zero degrees. More particularly, the rotors of the aerial vehicle will spin the most when a crosswind path of the aerial vehicle (e.g., when the aerial vehicle is in the crosswind flight mode) is perpendicular to the wind. Moreover, when the inclination angle is lower, components of the AWT system may experience less shear stress than configurations that create a greater inclination angle.

As such, it may be beneficial to place a gimbal assembly, which acts a point of rotation as the aerial vehicle goes around a closed loop flight path, at an elevation so that the center of the crosswind closed loop path maintains a constant and more efficient (i.e., lower) inclination angle to the wind. In scenarios where the gimbal assembly is located at or near a surface, such as the ground or surface of a body of water, the wing of the aerial vehicle may be at larger, less efficient inclination angles to the wind at various points along the closed loop. Therefore, it may be beneficial to locate the gimbal assembly at a higher elevation (e.g., between 50 m and 500 m above the ground) by coupling the gimbal assembly to a tower that extends vertically above the ground surface. Again, locating the gimbal assembly at an elevation may result is more efficient and better power production from the aerial vehicle. Furthermore, the gimbal assembly coupled to a taller tower may allow for operation at an inclination angle that reduces stress and strain on the tether and aerial vehicle, as well as other components. This also may increase reliability and the lifespan of the AWT system.

Such a configuration of the AWT system may also have other benefits. For example, for the same flight elevation, a length of the tether connecting the aerial vehicle to the gimbal assembly on a tall tower may be less than in a scenario with the gimbal assembly at or near the ground. Having a shorter tether may allow for small, more efficient loops as well as less overall weight that has to be supported by the aerial vehicle during takeoff, flight, and landing operations. Unlike tethered systems that may require complicated retrieval and/or launching mechanisms, AWT systems utilizing tower configurations disclosed herein may not require complex retrieval or launching systems such as reeling in an paying out a tether, among examples. In other examples, additional features may be designed into the tower that provide even more efficient takeoff, landing, and parking operations for the aerial vehicle. Such features may also mitigate or prevent accidental damage that may otherwise occur.

The Figures described in detail below are for illustrative purposes only and may not reflect all components or connections. Further, as illustrations the Figures may not reflect actual operating conditions, but are merely to illustrate embodiments described. For example, while a perfectly straight tether may be used to illustrate the described tether embodiments, during orbiting crosswind flight the tether may in practice exhibit some level of droop between the ground station and the aerial vehicle. Further still, the relative dimensions in the Figures may not be to scale, but are merely to illustrate the embodiments described.

### II. ILLUSTRATIVE SYSTEMS

A. Airborne Wind Turbine (AWT)

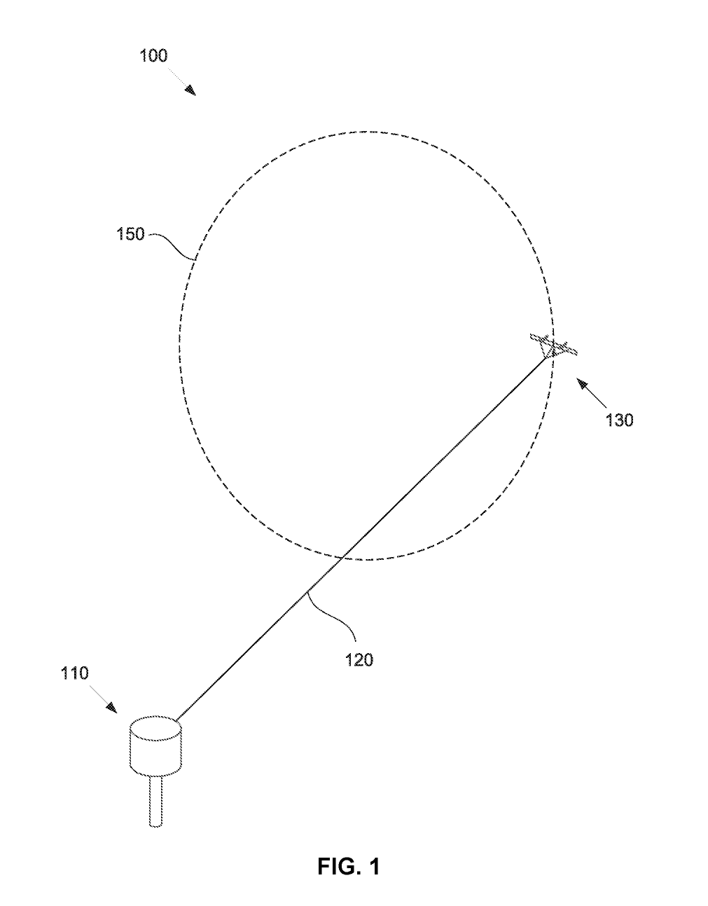

FIG. 1 depicts an AWT 100, according to an example embodiment. In particular, the AWT 100 includes a ground station 110, a tether 120, and an aerial vehicle 130. As shown in FIG. 1, the tether 120 may be connected to the aerial vehicle on a first end and may be connected to the ground station 110 on a second end. In this example, the tether 120 may be attached to the ground station 110 at one location on the ground station 110, and attached to the aerial vehicle 130 at three locations on the aerial vehicle 130. However, in other examples, the tether 120 may be attached at multiple locations to any part of the ground station 110 and/or the aerial vehicle 130.

The ground station 110 may be used to hold and/or support the aerial vehicle 130 until it is in an operational flight mode. The ground station 110 may also be configured to allow for the repositioning of the aerial vehicle 130 such that deploying of the aerial vehicle 130 is possible. Further, the ground station 110 may be further configured to receive the aerial vehicle 130 during a landing. The ground station 110 may be formed of any material that can suitably keep the aerial vehicle 130 attached and/or anchored to the ground while in hover flight, crosswind flight, and other flight modes, such as forward flight (which may be referred to as airplane-like flight). In some implementations, a ground station 110 may be configured for use on land. However, a ground station 110 may also be implemented on a body of water, such as a lake, river, sea, or ocean. For example, a ground station could include or be arranged on a floating offshore platform or a boat, among other possibilities. Further, a ground station 110 may be configured to remain stationary or to move relative to the ground or the surface of a body of water. Although not depicted in FIG. 1, the ground station 110 may further include a ground station gimbal or gimbal assembly that is supported by a tower. The tower may include other features such as a ring to support the aerial vehicle 130 and/or landing surfaces for the aerial vehicle 130 when the aerial vehicle 130 is not in flight. The tower may allow for AWT configurations that do not require active storage of the tether 120.

In addition, the ground station 110 may include one or more components (not shown), such as a winch, that may vary a length of the tether 120. For example, when the aerial vehicle 130 is deployed, the one or more components may be configured to pay out and/or reel out the tether 120. In some implementations, the one or more components may be configured to pay out and/or reel out the tether 120 to a predetermined length. As examples, the predetermined length could be equal to or less than a maximum length of the tether 120. Further, when the aerial vehicle 130 lands in or at the ground station 110, the one or more components may be configured to reel in the tether 120.

The tether 120 may transmit electrical energy generated by the aerial vehicle 130 to the ground station 110. In addition, the tether 120 may transmit electricity to the aerial vehicle 130 in order to power the aerial vehicle 130 for takeoff, landing, hover flight, and/or forward flight. The tether 120 may be constructed in any form and using any material which may allow for the transmission, delivery, and/or harnessing of electrical energy generated by the aerial vehicle 130 and/or transmission of electricity to the aerial vehicle 130. The tether 120 may also be configured to withstand one or more forces of the aerial vehicle 130 when the aerial vehicle 130 is in an operational mode. For example, the tether 120 may include a core configured to withstand one or more forces of the aerial vehicle 130 when the aerial vehicle 130 is in hover flight, forward flight, and/or crosswind flight. In some examples, the tether 120 may have a fixed length and/or a variable length. For instance, in at least one such example, the tether 120 may have a length of at least 70 meters. In another example, the tether 120 may have a length of 140 meters.

The aerial vehicle 130 may be configured to fly substantially along a closed path 150 to generate electrical energy. The term “substantially along,” as used in this disclosure, refers to exactly along and/or one or more deviations from exactly along that do not significantly impact generation of electrical energy.

The aerial vehicle 130 may include or take the form of various types of devices, such as a kite, a helicopter, a wing and/or an airplane, among other possibilities. The aerial vehicle 130 may be formed of solid structures of metal, plastic and/or other polymers. The aerial vehicle 130 may be formed of any material which allows for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction.

The closed path 150 may be various different shapes in various different embodiments. For example, the closed path 150 may be substantially circular. As the aerial vehicle 130 flies along the closed path 150 the aerial vehicle 130 may fly at various elevations. And in at least one example, the closed path 150 may have a radius of up to 265 meters. In other examples, the closed path 150 may have a radius that is 1.5 times a wingspan of the aerial vehicle 130. The term “substantially circular,” as used in this disclosure, refers to exactly circular and/or one or more deviations from exactly circular that do not significantly impact generation of electrical energy as described herein. Other shapes for the closed path 150 may be an oval, such as an ellipse, the shape of a jelly bean, the shape of the number of 8, etc.

The aerial vehicle 130 may be operated to travel along one or more revolutions of the closed path 150.

B. Illustrative Components of an AWT

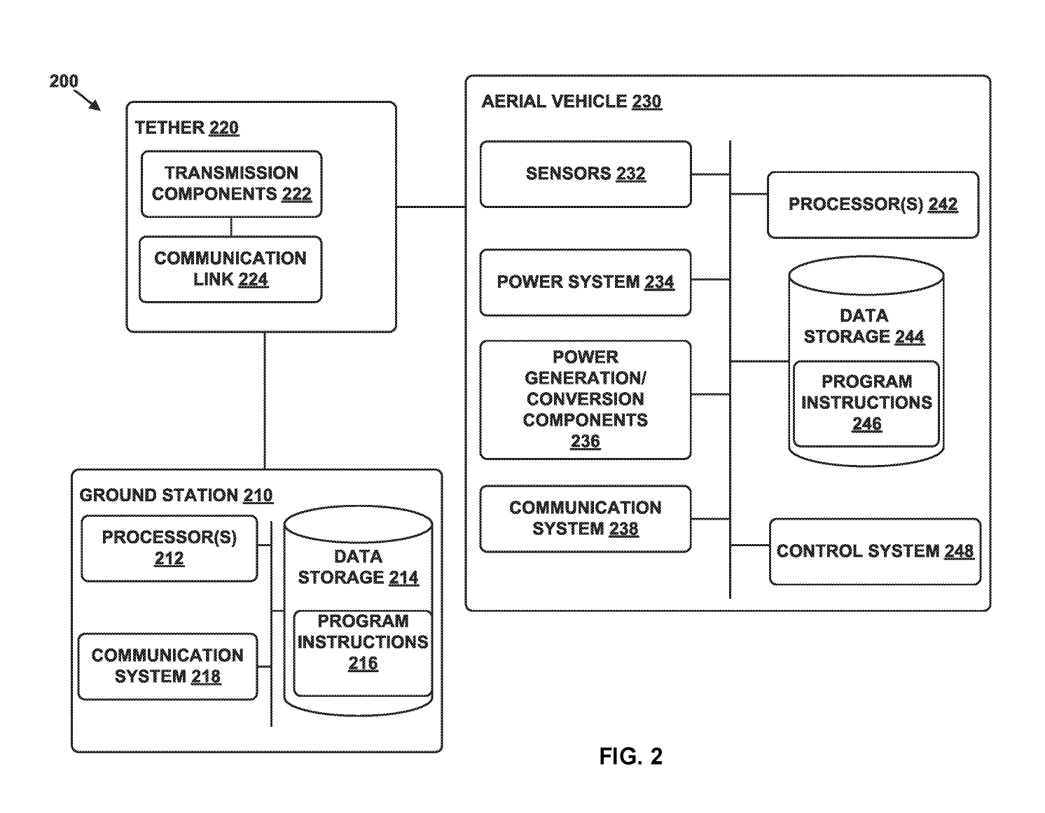

FIG. 2 is a simplified block diagram illustrating components of the AWT 200. The AWT 100 may take the form of or be similar in form to the AWT 200. In particular, the AWT 200 includes a ground station 210, a tether 220, and an aerial vehicle 230. The ground station 110 may take the form of or be similar in form to the ground station 210, the tether 120 may take the form of or be similar in form to the tether 220, and the aerial vehicle 130 may take the form of or be similar in form to the aerial vehicle 230.

As shown in FIG. 2, the ground station 210 may include one or more processors 212, data storage 214, and program instructions 216. A processor 212 may be a general-purpose processor or a special purpose processor (e.g., digital signal processors, application specific integrated circuits, etc.). The one or more processors 212 can be configured to execute computer-readable program instructions 216 that are stored in a data storage 214 and are executable to provide at least part of the functionality described herein.

The data storage 214 may include or take the form of one or more computer-readable storage media that may be read or accessed by at least one processor 212. The one or more computer-readable storage media can include volatile and/or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments, the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include a communication system 218. The communication system 218 may include one or more wireless interfaces and/or one or more wireline interfaces, which allow the ground station 210 to communicate via one or more networks. Such wireless interfaces may provide for communication under one or more wireless communication protocols, such as Bluetooth, Wi-Fi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ground station 210 may communicate with the aerial vehicle 230, other ground stations, and/or other entities (e.g., a command center) via the communication system 218.

In an example embodiment, the ground station 210 may include communication systems 218 that allows for both short-range communication and long-range communication. For example, the ground station 210 may be configured for short-range communications using Bluetooth and for long-range communications under a CDMA protocol. In such an embodiment, the ground station 210 may be configured to function as a “hotspot”; or in other words, as a gateway or proxy between a remote support device (e.g., the tether 220, the aerial vehicle 230, and other ground stations) and one or more data networks, such as cellular network and/or the Internet. Configured as such, the ground station 210 may facilitate data communications that the remote support device would otherwise be unable to perform by itself.

For example, the ground station 210 may provide a Wi-Fi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command center, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 and/or transmit electrical energy from the ground station 210 to the aerial vehicle 230. The transmission components 222 may take various different forms in various different embodiments. For example, the transmission components 222 may include one or more electrical conductors that are configured to transmit electricity. And in at least one such example, the one or more electrical conductors may include aluminum and/or any other material which allows for the conduction of electric current. Moreover, in some implementations, the transmission components 222 may surround a core of the tether 220 (not shown).

The ground station 210 could communicate with the aerial vehicle 230 via the communication link 224. The communication link 224 may be bidirectional and may include one or more wired and/or wireless interfaces. Also, there could be one or more routers, switches, and/or other devices or networks making up at least a part of the communication link 224.

Further, as shown in FIG. 2, the aerial vehicle 230 may include one or more sensors 232, a power system 234, power generation/conversion components 236, a communication system 238, one or more processors 242, data storage 244, program instructions 246, and a control system 248.

The sensors 232 could include various different sensors in various different embodiments. The sensors 232 may also include one or more probes coupled to strength members of the tether 220. In another example, the sensors 232 may further include a global positioning system (GPS) receiver. The GPS receiver may be configured to provide data that is typical of well-known GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to detect apparent and/or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEMS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, slight errors in measurement may compound over time and result in a more significant error. However, an example aerial vehicle 230 may be able to mitigate or reduce such errors by using a magnetometer to measure direction. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of and/or prevent drift of the IMU. In addition, the aerial vehicle 230 may include one or more load cells configured to detect forces distributed between a connection of the tether 220 to the aerial vehicle 230.

As noted, the aerial vehicle 230 may include the power system 234. The power system 234 could take various different forms in various different embodiments. For example, the power system 234 may include one or more batteries for providing power to the aerial vehicle 230. In some implementations, the one or more batteries may be rechargeable and each battery may be recharged via a wired connection between the battery and a power supply and/or via a wireless charging system, such as an inductive charging system that applies an external time-varying magnetic field to an internal battery and/or charging system that uses energy collected from one or more solar panels.

As another example, the power system 234 may include one or more motors or engines for providing power to the aerial vehicle 230. In some implementations, the one or more motors or engines may be powered by a fuel, such as a hydrocarbon-based fuel. And in such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 236 could take various different forms in various different embodiments. For example, the power generation/conversion components 236 may include one or more generators, such as high-speed, direct-drive generators. With this arrangement, the one or more generators may be driven by one or more rotors. And in at least one such example, the one or more generators may operate at full rated power wind speeds of 11.5 meters per second at a capacity factor which may exceed 60 percent, and the one or more generators may generate electrical power from 40 kilowatts to 600 megawatts.

Moreover, as noted, the aerial vehicle 230 may include a communication system 238. The communication system 238 may take the form of or be similar in form to the communication system 218. The aerial vehicle 230 may communicate with the ground station 210, other aerial vehicles, and/or other entities (e.g., a command center) via the communication system 238.

In some implementations, the aerial vehicle 230 may be configured to function as a “hotspot”; or in other words, as a gateway or proxy between a remote support device (e.g., the ground station 210, the tether 220, other aerial vehicles) and one or more data networks, such as cellular network and/or the Internet. Configured as such, the aerial vehicle 230 may facilitate data communications that the remote support device would otherwise be unable to perform by itself.

For example, the aerial vehicle 230 may provide a Wi-Fi connection to the remote device, and serve as a proxy or gateway to a cellular service provider's data network, which the aerial vehicle 230 might connect to under an LTE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 246, and the data storage 244. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems and/or with hardware, firmware, and/or software. As one example, the control system 248 may take the form of program instructions stored on a non-transitory computer readable medium and a processor that executes the instructions. The control system 248 may be implemented in whole or in part on the aerial vehicle 230 and/or at least one entity remotely located from the aerial vehicle 230, such as the ground station 210. Generally, the manner in which the control system 248 is implemented may vary, depending upon the particular application.

While the aerial vehicle 230 has been described above, it should be understood that the methods and systems described herein could involve any suitable aerial vehicle that is connected to a tether, such as the tether 220 and/or the tether 120.

C. Illustrative Aerial Vehicle

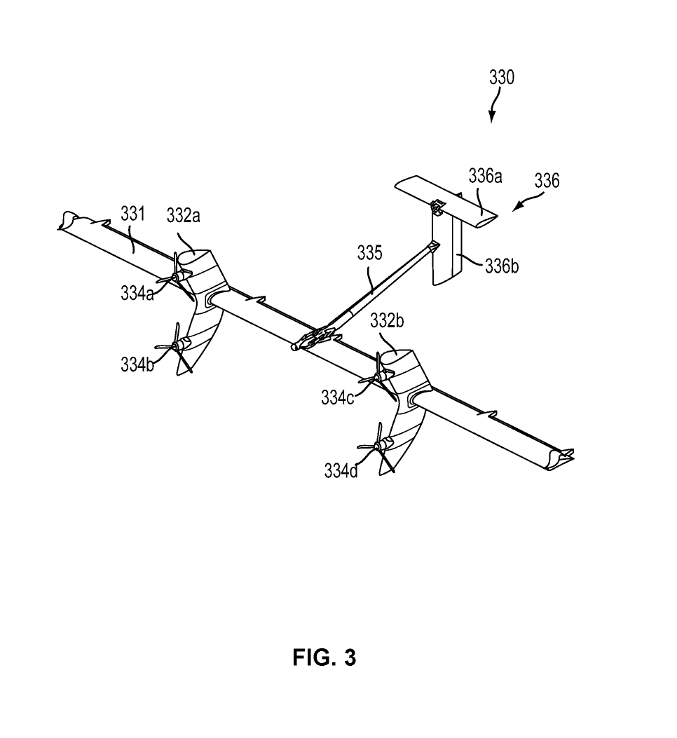

FIG. 3 depicts an aerial vehicle 330, according to an example embodiment. The aerial vehicle 130 and/or the aerial vehicle 230 may take the form of or be similar in form to the aerial vehicle 330. In particular, the aerial vehicle 330 may include a main wing 331, pylons 332a, 332b, rotors 334a, 334b, 334c, 334d, a tail boom 335, and a tail wing assembly 336. Any of these components may be shaped in any form which allows for the use of components of lift to resist gravity and/or move the aerial vehicle 330 forward.

The main wing 331 may provide a primary lift force for the aerial vehicle 330. The main wing 331 may be one or more rigid or flexible airfoils, and may include various control surfaces, such as winglets, flaps (e.g., Fowler flaps, Hoerner flaps, split flaps, and the like), rudders, elevators, spoilers, dive brakes, etc. The control surfaces may be used to stabilize the aerial vehicle 330 and/or reduce drag on the aerial vehicle 330 during hover flight, forward flight, and/or crosswind flight.

The main wing 331 and pylons 332a, 332b may be any suitable material for the aerial vehicle 330 to engage in hover flight, forward flight, and/or crosswind flight. For example, the main wing 331 and pylons 332a, 332b may include carbon fiber and/or e-glass, and include internal supporting spars or other structures. Moreover, the main wing 331 and pylons 332a, 332b may have a variety of dimensions. For example, the main wing 331 may have one or more dimensions that correspond with a conventional wind turbine blade. As another example, the main wing 331 may have a span of 8 meters, an area of 4 meters squared, and an aspect ratio of 15.

The pylons 332a, 332b may connect the rotors 334a, 334b, 334c, and 334d to the main wing 331. In some examples, the pylons 332a, 332b may take the form of, or be similar in form to, a lifting body airfoil (e.g., a wing). In some examples, a vertical spacing between corresponding rotors (e.g., rotor 334a and rotor 334b on pylon 332a) may be 0.9 meters.

The rotors 334a, 334b, 334c, and 334d may be configured to drive one or more generators for the purpose of generating electrical energy. In this example, the rotors 334a, 334b, 334c, and 334d may each include one or more blades, such as three blades or four blades. The rotor blades may rotate via interactions with the wind and be used to drive the one or more generators. In addition, the rotors 334a, 334b, 334c, and 334d may also be configured to provide thrust to the aerial vehicle 330 during flight. With this arrangement, the rotors 334a, 334b, 334c, and 334d may function as one or more propulsion units, such as a propeller. Although the rotors 334a, 334b, 334c, and 334d are depicted as four rotors in this example, in other examples the aerial vehicle 330 may include any number of rotors, such as less than four rotors or more than four rotors (e.g., eight rotors).

A tail boom 335 may connect the main wing 331 to the tail wing assembly 336, which may include a tail wing 336a and a vertical stabilizer 336b. The tail boom 335 may have a variety of dimensions. For example, the tail boom 335 may have a length of 2 meters. Moreover, in some implementations, the tail boom 335 could take the form of a body and/or fuselage of the aerial vehicle 330. In such implementations, the tail boom 335 may carry a payload.

The tail wing 336a and/or the vertical stabilizer 336b may be used to stabilize the aerial vehicle 330 and/or reduce drag on the aerial vehicle 330 during hover flight, forward flight, and/or crosswind flight. For example, the tail wing 336a and/or the vertical stabilizer 336b may be used to maintain a pitch of the aerial vehicle 330 during hover flight, forward flight, and/or crosswind flight. The tail wing 336a and the vertical stabilizer 336b may have a variety of dimensions. For example, the tail wing 336a may have a length of 2 meters. Moreover, in some examples, the tail wing 336a may have a surface area of 0.45 meters squared. Further, in some examples, the tail wing 336a may be located 1 meter above a center of mass of the aerial vehicle 330.

While the aerial vehicle 330 has been described above, it should be understood that the systems described herein could involve any suitable aerial vehicle that is connected to an airborne wind turbine tether, such as the tether 120 and/or the tether 220.

D. Aerial Vehicle Coupled to a Ground Station Via a Tether

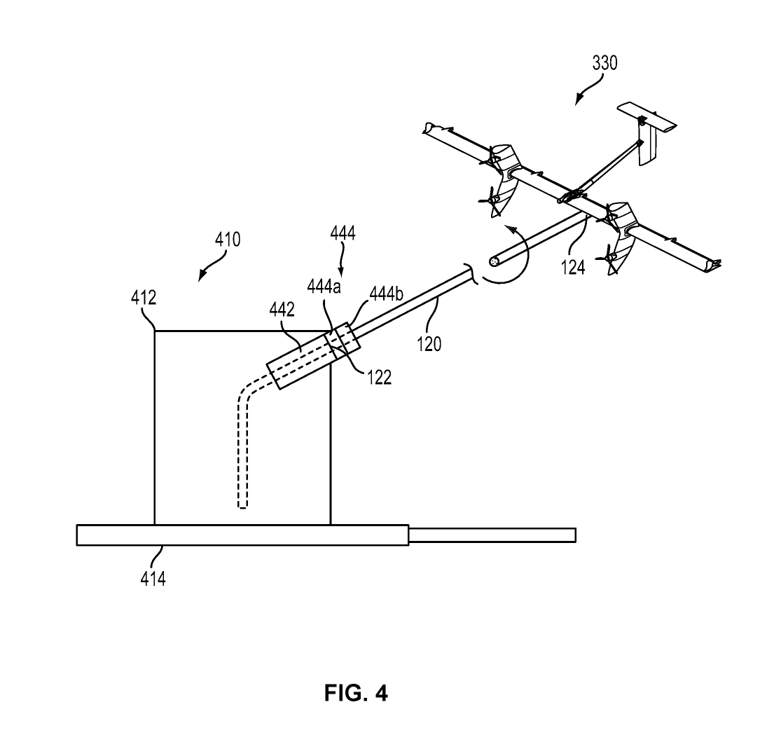

FIG. 4 depicts the aerial vehicle 330 coupled to a ground station 410 via the tether 120, according to an example embodiment. Referring to FIG. 4, the ground station 410 may include a drum 412 and a platform 414. The ground station 110 and/or the ground station 210 may take the form of or be similar in form to the ground station 410. FIG. 4 is for illustrative purposes only and may not reflect all components or connections.

As shown in FIG. 4, the tether 120 may be coupled to a gimbal assembly 442 at a proximate tether end 122 and to the aerial vehicle 330 at a distal tether end 124. Additionally or alternatively, at least a portion of the tether 120 (e.g., at least one electrical conductor) may pass through the gimbal assembly 442. In some embodiments, the tether 120 may terminate at the gimbal assembly 442. Moreover, as shown in FIG. 4, the gimbal assembly 442 may also be coupled to the drum 412 which in turn may be coupled to the platform 414. The aerial vehicle 330 may perch or land on the platform 414 when the aerial vehicle 330 is not in flight. In some embodiments, the tether gimbal assembly 442 may be configured to rotate about one or more axes, such as an altitude axis and an azimuth axis, in order to allow the proximate tether end 122 to move in those axes in response to movement of the aerial vehicle 330.

A rotational component 444 located between the tether 120 and the gimbal assembly 442 may allow the tether 120 to rotate about the long axis of the tether 120. The long axis is defined as extending between the proximate tether end 122 and the distal tether end 124. In some embodiments, at least a portion of the tether 120 may pass through the rotational component 444. Moreover, in some embodiments, the tether 120 may pass through the rotational component 444. Further, in some embodiments, the rotational component 444 may include a fixed portion 444a and a rotatable portion 444b, for example, in the form of one or more bearings and/or slip rings. The fixed portion 444a may be coupled to the tether gimbal assembly 442. The rotatable portion 444b may be coupled to the tether 120.

The use of the word fixed in the fixed portion 444a of the rotational component 444 is not intended to limit fixed portion 444a to a stationary configuration. In this example, the fixed portion 444a may move in axes described by the gimbal assembly 442 (e.g., altitude and azimuth), and may rotate about the ground station 410, but the fixed portion 444a will not rotate about the tether 120, i.e., with respect to the long axis of the tether 120. Moreover, in this example, the rotatable portion 444b of the rotational component 444 may be coupled to the tether 120 and configured to substantially rotate with the rotation of tether 120.

Via the rotational component 444, the tether 120 may rotate about its centerline along the long axis as the aerial vehicle 330 orbits. The distal tether end 124 may rotate a different amount than the proximate tether end 122, resulting in an amount of twist along the length of the tether 420. With this arrangement, the amount of twist in the tether 420 may vary based on a number of parameters during crosswind flight of the aerial vehicle 330.

### III. ILLUSTRATIVE AWT TOWERS

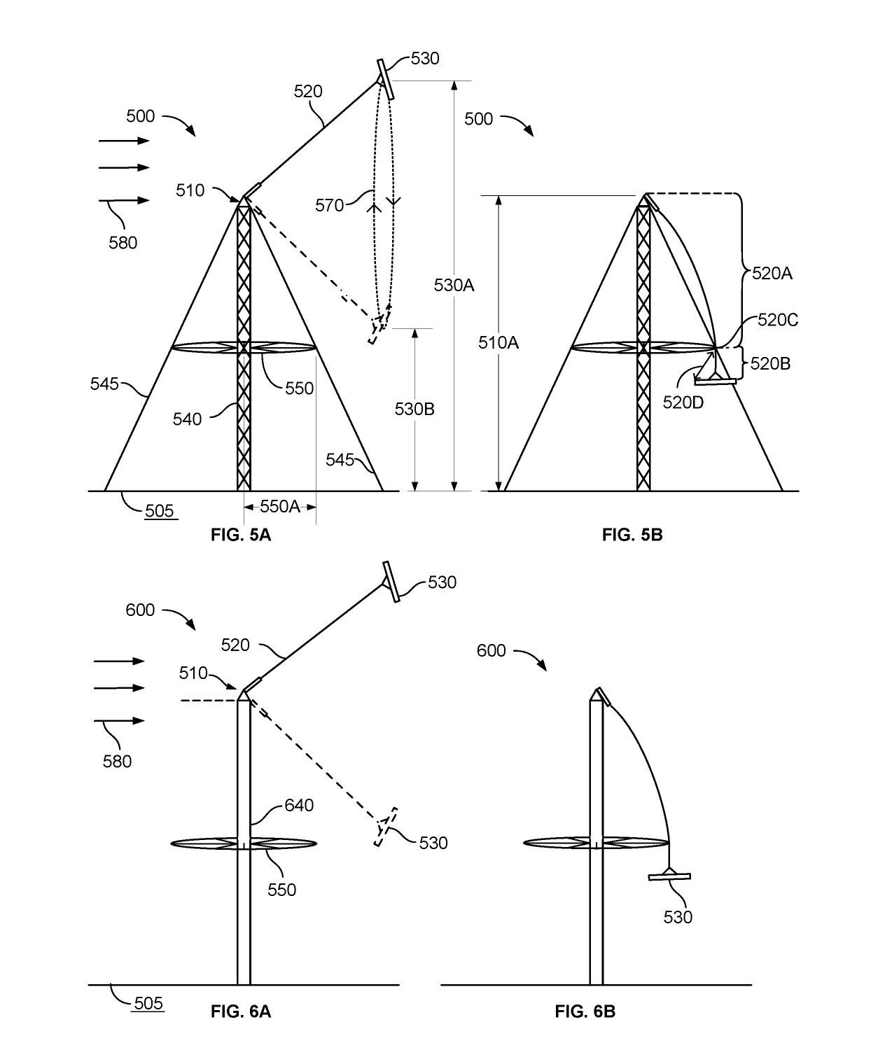

FIG. 5A and FIG. 5B depict an AWT 500 in a first operational mode and a second operational mode, respectively, according to an example embodiment. Example operational modes include a parked mode (when an aerial vehicle is at rest or parked), a hover flight mode, and a power generating flight mode (or a crosswind flight mode), among other possibilities. As illustrated, the AWT 500 is in a power generating flight mode in FIG. 5A, while the AWT 500 is in a parked mode in FIG. 5B.

The AWT 500 may take the form of or be similar in form to the AWT 200 of FIG. 2 and/or the AWT 100 of FIG. 1. As depicted in FIG. 5A and FIG. 5B, the AWT 500 includes a gimbal assembly 510, a tether 520, an aerial vehicle 530, and a tower 540. The tower 540 includes a plurality of guy wires 545 and a ring 550. The gimbal assembly 510 is capable of moving in multiple axes relative to the tower 540 in order to facilitate movement of the tether 520. The guy wires 545 are secured to a surface 505 (a ground surface or a floating platform) and stabilize the tower 540 against tension in the tether 510 from the aerial vehicle 530.

As shown in FIG. 5A, a wind 580 may be blowing at a speed such that the AWT 500 may generate electricity and thus, the aerial vehicle 530 may be in power generating flight mode (e.g., a crosswind flight mode of operation). While in the power generating flight mode, the aerial vehicle 530 may be traveling along a closed path 570 (that may be similar to closed path 150 of FIG. 1). The tether 520 may be coupled to the gimbal assembly 510 at a first end of the tether 520. Further, the tether 520 may be coupled to the aerial vehicle 530 at a second end of the tether 520. In some aspects, the tether 520 may include a bridle at the second end and the bridle may be coupled to the aerial vehicle 530. In some embodiments, a length of the tether 520 between the gimbal assembly 510 and the aerial vehicle 530 is fixed.

The gimbal assembly 510 may be coupled to the tower 540. Preferably, the gimbal assembly 510 is coupled to the tower 540 at an elevation 510A between about 50 m and about 500 m above the surface 505. More preferably, the gimbal assembly 510 is coupled to the tower 540 at an elevation 510A between about 90 m and about 150 m above the surface 505. In some aspects, the gimbal assembly 510 may be coupled at the top or to a highest point of the tower 540. In other aspects, the gimbal assembly 510 may be coupled below the top of the tower 540. The gimbal assembly 510 may act as a point of rotation for the aerial vehicle 530 and tether 520 when the aerial vehicle 530 is in the power generating flight mode. The elevated location of the gimbal assembly 510 may allow for shorter tether lengths (e.g. 70 meters) compared to lower ground station designs, as well as tethers that are heavier per meter than a carbon fiber tether. Moreover, by locating the gimbal assembly 510 at the elevation 510A such that there is a low inclination angle, shear stresses experienced by components of the AWT 500 may be reduced.

Further, as described above, energy may be more efficiently generated when an inclination angle is reduced or closer to zero degrees. The inclination angle is an angle between a line from the gimbal assembly 510 to a center of the closed loop flight path 570 the aerial vehicle 530 travels and a direction of the wind 580 when the aerial vehicle 530 is in the power generating mode or crosswind flight mode. Within examples, a plane of the closed path 570 may be normal to the direction of the wind 580 and normal to the surface 505 when the inclination angle is zero degrees. In some embodiments, the inclination angle is less than five degrees. In other embodiments, the inclination angle is less than thirty degrees. The inclination angle may be at least partly based on the elevation 510A.

Furthermore, in order to operate within the power generating mode, the aerial vehicle 530 must be above a certain elevation from the ground surface 505. In scenarios where the gimbal assembly 510 is located on or near the ground surface 505, a similar AWT system would require a longer and heavier tether to get the aerial vehicle 530 up to an elevation at which energy may be generated efficiently (i.e., low inclination angle). Thus, the AWT 500, with the tower 540 that locates the gimbal assembly 510 at the elevation 510A, allows the aerial vehicle 530 to be in the power generating mode with a shorter length tether 520 while maintaining or increasing efficiency of power generation.

Moreover, if the gimbal assembly 510 was located on the ground surface 505, when the aerial vehicle 530 was in crosswind flight, the aerial vehicle 530 alone would be supporting the entire length of the tether 520 that would be entirely above the gimbal assembly 510 at all times during crosswind flight. However, when the gimbal assembly 510 is elevated to a range of altitudes that the aerial vehicle 530 flies at during crosswind flight, the gimbal assembly 510 (and the support tower 540) take at least a portion of the loading caused by the weight of the tether 520 when the aerial vehicle 530 is at an elevation less than the elevation 510A.

As depicted in FIG. 5A, the tower 540 may include a lattice structure that is fixed to the surface 505. The lattice structure of the tower 540 may include a series of metal posts or beams that are configured to support a mass of the gimbal assembly 510. Tension from the aerial vehicle 530 in power generating flight mode may be transferred from the tether 520 to the plurality of guy wires 545 which may also be fixed to the surface 505. The tower 540 with a lattice configuration may have low mass and a low cost when compared to existing traditional onshore wind towers. Moreover, because the AWT 500 utilizes the aerial vehicle 530 for electricity generation, the tower 540 may be configured to bend within an allowance without concern for a loss of operational capacity from the aerial vehicle 530 in the wind 580. Beneficially, a stiff, bulky, upright tower to support a large top head mass (e.g., a conventional turbine, generator, etc.) is not necessary.

FIG. 6A and FIG. 6B depict an AWT 600, according to another example embodiment. The AWT 600 may take the form of, or be similar in form to, the AWT 500, except as indicated below. Similar to AWT 500, the AWT 600 includes a gimbal assembly 510, a tether 520, an aerial vehicle 530, and a ring 550. These components of the AWT 600 may have similar function as in the AWT 500. In FIG. 6A, the aerial vehicle 530 is depicted flying in a power generating flight mode similar to FIG. 5A, and in FIG. 6B, the aerial vehicle is shown in a parked mode, similar to FIG. 5B. Power generating flight mode and parked mode would function similarly in both AWT 500 and AWT 600.

Unlike as in the AWT 500, the tower 640 is a tubular tower that extending upwards from a surface 505. Despite having a different design, the AWT 600 may still present similar benefits as the AWT 500 of FIG. 5. The tower 640 may still need to support tensions during crosswind flight of the aerial vehicle 530 similar to loading experienced by more traditional towers, the tower 640 may still have a relatively lower mass than more traditional wind turbine towers and the tower 640 does not have to support a top head mass of the magnitude of more traditional wind turbine engines and blades. Although more rigid than a lattice tower (e.g., the tower 540 of FIG. 5), because the tower 640 does not need to be as rigid or carry as much of a top mass load as a traditional wind turbine tower, it may also be relatively lower in cost.

A ring 550 may be coupled to the tower 540 or tower 640 between the surface 505 and the gimbal assembly 510. In some embodiments of AWT 500, the ring 550 may be coupled to and/or supported by the plurality of guy wires 545. In some embodiments of AWT 500 or AWT 600, the ring 550 may be supported by other guy wires that may or may not be connected the tower 540 and/or the surface 505. The ring 550 extends some distance radially from the tower 540 or the tower 640. In some embodiments, the ring 550 may be centered around the tower 540 or the tower 640. The ring 550 may be coupled about the tower 540 or the tower 640 in a plane normal to the tower 540 or tower 640.

As depicted in FIGS. 5A-6B, the ring 550 may be coupled at an elevation above the surface 505 and along the tower 540 or tower 640 such that when the aerial vehicle 530 is in a parked mode, the aerial vehicle 530 may hang from the gimbal assembly 510, such that the tether 520 supports the weight of the vehicle. The ring 550 may contact the tether 520 at a contact point 520C and bias the tether 520 and the aerial vehicle 530 away from the tower 540 or the tower 640. The contact point 520C may include a special coating or additional or different material configured to withstand and/or facilitate the contact between the ring 550 and the tether 520.

When the aerial vehicle 530 is in parked mode, a first portion 520A of the tether 520 may hang from the gimbal assembly 510 to the ring 550. A second portion 520B of the tether 520 may hang below the ring 550. In this configuration, the tether 520 is supporting the weight of the aerial vehicle 530.

When the aerial vehicle 530 is in parked mode, the ring 550 may prevent the aerial vehicle 530 from contacting the tower 540, the tower 640, or other components of the AWT 500 or AWT 600. In other words, the ring 550 may provide clearance around the aerial vehicle 530 in a parked condition to prevent or lessen any damage caused by accident or failure of the AWT 500 or AWT 600. To do so, a linear distance 520D from the contact point 520C to a furthest end of the aerial vehicle 530 from the tether 520 is less than the radial distance 550A of the ring 550 from the tower 540 or tower 640.

The ring 550 may have a curved outer surface area at the contact point 520C, i.e. in a direction radially outward from the tower 540 or tower 640, that is large enough to support a bend radius of the tether 520. Additionally or alternatively, the ring 550 and/or the tether 520 at the contact point 520C may also include features such as a snap fit or other mechanical coupling mechanism (e.g. clasps, magnets, etc.) that is configured to connect and hold the tether 520 in a fixed position up against the ring 550. The coupling mechanism may be passive, i.e., the tether 520 and the ring 550 will couple once they come into contact, or the coupling mechanism may be an active system that locates and/or secures the tether 520. In another embodiment, the ring 550 may include components or mechanisms that are configured to couple to the bridle between the tether 520 and the aerial vehicle 530. Coupling the ring 550 to the bridle may reduce a roll moment of the aerial vehicle 530 as the aerial vehicle 530 hangs in a parked configuration.

As shown FIGS. 5A and 6A, when the aerial vehicle 530 is in the power generating flight mode, the aerial vehicle 630 may have an maximum flight altitude 530A above the surface 505 when it is at the top of the closed loop flight path 570. Similarly, the aerial vehicle 530 may have an minimum flight altitude 530B above the surface 505 when it is at the bottom of the closed loop flight path 570. As shown in FIGS. 5B and 6B, when the aerial vehicle 530 is in a parked configuration where the tether 520 is in contact with the ring 550 at the contact point 520C, the aerial vehicle 530 may have an elevation 530C above the surface 505.

As such, the tower 540 or tower 640, and the ring 550, may be a fail-safe for the AWT 500 or AWT 600 in case of a failure. For example, if the aerial vehicle 530 were to lose power while in a power generating flight mode, the arrangement of AWT or AWT 600 would mitigate risk of the aerial vehicle 530 contacting or damaging the tower 540, the tower 640, or any of the environment surrounding the AWT 500 or AWT 600, e.g. structures or people on the ground surface 505.

In one embodiment, the elevation 510A (i.e., the elevation of the gimbal assembly 510), may be more than the minimum flight altitude 530B but less than the maximum flight altitude 530A. As such, when the aerial vehicle 530 is in the power generating flight mode (e.g., crosswind flight mode), energy generation components (e.g., rotors) of the aerial vehicle 530 may be more efficiently positioned or angled in the wind 580. Thus, the elevation 510A of the gimbal assembly 510 may reduce the inclination angle between a direction of the wind 580 and the center of the closed loop flight path 570 relative the gimbal assembly 510 in power generation mode. In another embodiment, the elevation 510A may be halfway between the minimum flight altitude 530B and the maximum flight altitude 530A of the aerial vehicle 530. In such an example, the elevation 510A of the gimbal assembly 510 may be at the same elevation as the center of the closed flight path 570 (i.e., the inclination angle is zero and the plane of the closed flight path 570 is perpendicular to the wind 580 and the ground 505).

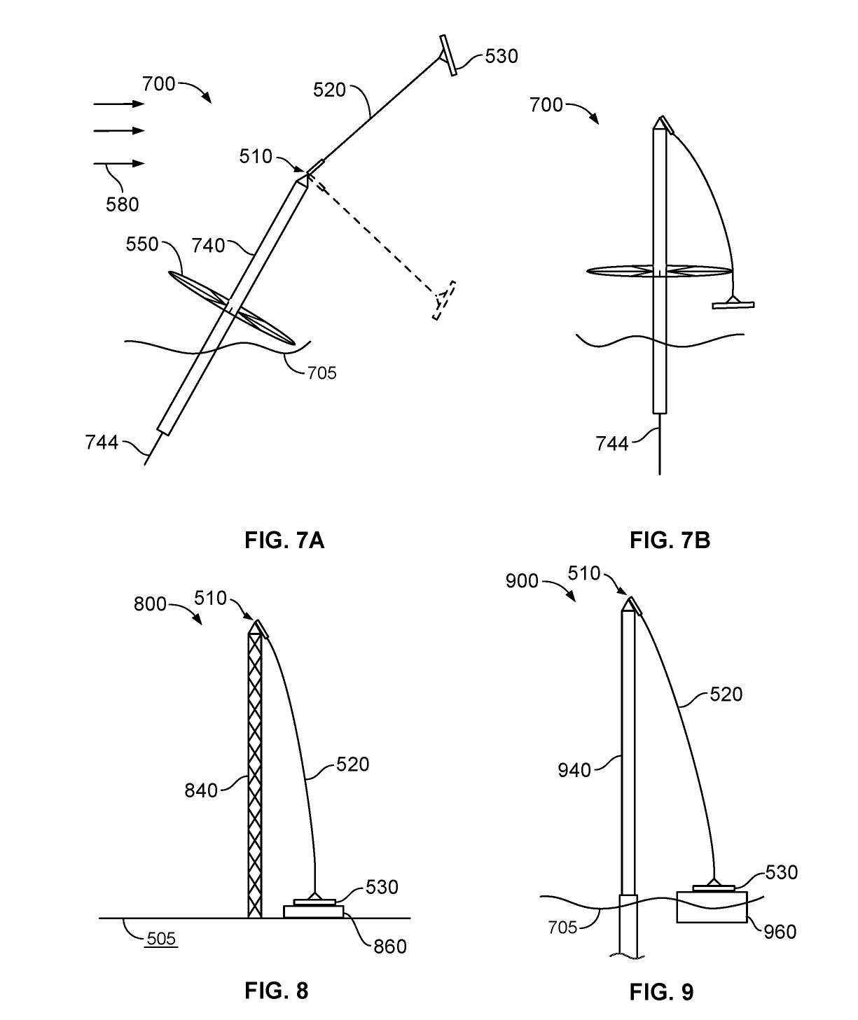

FIG. 7A and FIG. 7B depict an AWT 700, according to another example embodiment. The AWT 700 may take the form of, or be similar in form to, the AWT 500, except as indicated below. Similar to AWT 500, the AWT 700 includes a gimbal assembly 510, a tether 520, an aerial vehicle 530, and a ring 550. These components of the AWT 700 may have similar function as in the AWT 500. In FIG. 7A, the aerial vehicle 530 is depicted flying in a power generating flight mode similar to FIG. 5A, and in FIG. 7B, the aerial vehicle is shown in a parked configuration, similar to FIG. 5B. Power generating flight mode and parked mode would function similarly in both AWT 500 and AWT 700.

Unlike as in the AWT 500, the AWT 700 is an offshore AWT design. As such, the tower 740 may include or be constructed from a buoy. The tower 740 may be configured to float in a body of water with a surface 705, with the tower 740 extending upward from a surface 705, as well as extending below the surface 705. Portions of the tower 740 may tubular, solid, lattice, or other structural designs. The tower 740 may be allowed to tilt in a direction of the wind 580 when the aerial vehicle 530 is in power generating flight mode. The tension from the aerial vehicle 530 in flight may be distributed to an anchor cable 744 that is secured below the surface 705 (e.g., by anchor, tension lines, or guy wires) and also coupled to the tower 740. Allowing the tower 740 to tilt may assist in locating the aerial vehicle 530 in a more efficient position relative to the wind 580. Further, the tower 740 of the AWT 700 allows for offshore wind generation without the cost of constructing a rigid tower that has to remain nearly perfectly vertical in order to operate. In some examples, the tower 740 may be configured to tilt up to 50 degrees from vertical). In park mode (or when not in power generating flight mode), the aerial vehicle 530 may exert less than a significant tilting force on the tower 740 and the tower 740 can return to a stable upright orientation.

FIG. 8 depicts an AWT 800, according to another example embodiment. The AWT 800 may take the form of or be similar in form to the AWT 600 of FIGS. 6A and 6B, the AWT 500 of FIGS. 5A and 5B, the AWT 200 of FIG. 2, and/or the AWT 100 of FIG. 1. As depicted in FIG. 8, the AWT 800 includes a gimbal assembly 510, a tether 520, an aerial vehicle 530, and a tower 840. Further, components of the AWT 800 may take similar form and have similar function to components of the AWT 600 of FIGS. 6A and 6B, and the AWT 500 of FIGS. 5A and 5B. The tower 840 may be constructed as a lattice tower, similar to the tower 540 of FIGS. 5A and 5B. In another embodiment, the tower 840 may be a tubular tower or equivalent.

In addition to the other components, the AWT 800 further includes a landing platform 860. The landing platform 860 may be located onshore and include supporting structures to assist the aerial vehicle 530 in parking or perching when the aerial vehicle 530 is not in flight. In this example embodiment, the tether 520 may be long enough such that the aerial vehicle 530 can land at the landing platform 860. In some examples, the landing platform 860 may be fixed, while in other examples the landing platform 860 may be allowed to move autonomously or under remotely control. When parked on the landing platform 860 the aerial vehicle is in a parked mode, and the aerial vehicle 530 may charge batteries, download or upload information, undergo mechanical maintenance, or otherwise be maintained. The landing platform 860 may further provide means for allowing the aerial vehicle 530 to perch in a vertical orientation.

FIG. 9 depicts an AWT 900, according to another example embodiment. The AWT 900 may take the form of or be similar in form to the AWT 700 of FIGS. 7A and 7B, the AWT 600 of FIGS. 6A and 6B, the AWT 500 of FIGS. 5A and 5B, the AWT 200 of FIG. 2, and/or the AWT 100 of FIG. 1. As depicted in FIG. 9, the AWT 900 includes a gimbal assembly 510, a tether 520, an aerial vehicle 530, a tower 940, and a landing platform 960. The landing platform 960 may be located offshore. In some examples the landing platform 960 may be a floating platform. The tower 940 may be constructed as a buoy tower, similar to the tower 740 of FIGS. 7A and 7B.

Further, components of the AWT 900 may take similar form and have similar function to components of the AWT 700 of FIGS. 7A and 7B, the AWT 600 of FIGS. 6A and 6B, and the AWT 500 of FIGS. 5A and 5B. In some embodiments, the tower 940 may be partially constructed as a lattice tower, similar to the tower 540 of FIGS. 5A and 5B.

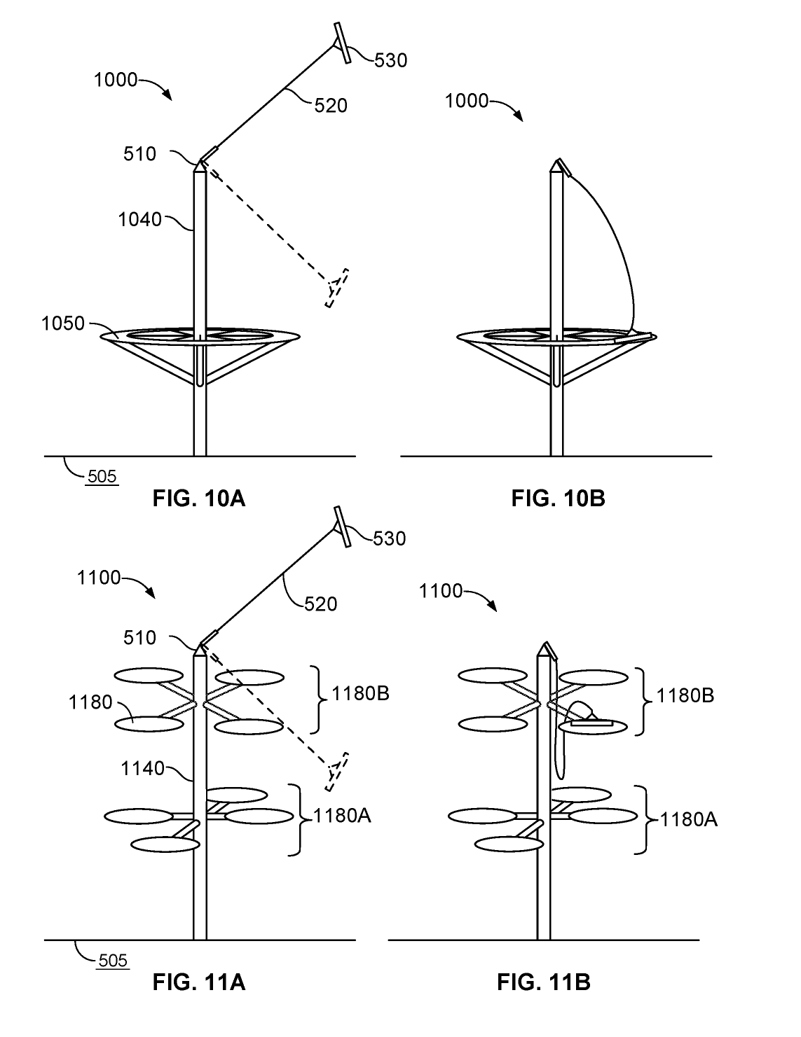

FIG. 10A and FIG. 10B depict an AWT 1000, according to another example embodiment. The AWT 1000 may take the form of, or be similar in form to, the AWT 500, except as indicated below. Similar to AWT 500, the AWT 1000 includes a gimbal assembly 510, a tether 520, and an aerial vehicle 530. These components of the AWT 1000 may have similar function as in the AWT 500. In FIG. 10A, the aerial vehicle 530 is depicted flying in a power generating flight mode similar to FIG. 5A, and in FIG. 10B, the aerial vehicle is shown in a parked configuration. Power generating flight mode would function similarly in both AWT 500 and AWT 1000.

Unlike as in the AWT 500, the AWT 1000 is a landing platform design. As such, a landing surface 1050 is coupled to the tower 1040 between the base surface 505 and the gimbal assembly 510. Similar to the ring 550, the landing surface 1050 extends radially from the tower some radial distance. The landing surface 1050 may be considered a landing platform in some embodiments, and moreover, the landing surface 1050 may include components and aspects of the landing platform 860 of FIG. 8 or the landing platform 960 of FIG. 9. The landing surface 1050 may take the form of an annular track that surrounds at least a portion of the tower 1040.

The AWT 500 is configured such that the aerial vehicle 530 is capable of landing on the landing surface 1050 in a parked mode, but not capable of crashing into the surface 505 in the event of a failure. To accomplish this, the linear distance along the length of the tether 520 from the gimbal to a furthest end of the aerial vehicle 530 from the tether 520 is less than the elevation distance of the gimbal 510 above the base surface 505. In practical terms, the tether 520 is too short to allow the aerial vehicle 530 to touch the surface 505. In some embodiments, the tether 520 may be significantly longer than the distance from the gimbal 510 to the landing surface 1050. In such embodiments, the landing surface 1050 may further be arranged to function similarly to the ring 550, such that landing surface 1050 has an outer contact surface configured to contact the tether so the aerial vehicle 530 can hang from tether 520 and not contact the surface 505 or the tower 1040, similar to AWT 500. This would be beneficial in the event of a failure of the AWT 1000.

While a single landing surface 1050 is depicted, more than one landing surface 1050 may be coupled to the tower 1040. For example, two or more landing surfaces may be coupled to the tower, and those landing surfaces may have other configurations (e.g., half circle annular tracks), may be at multiple elevations along the tower 1040, and/or may be coupled to the tower 1040 at different radial locations (e.g., one landing surface on a North side of the tower 1040 and one landing surface on a South side of the tower 1040). Moreover, the landing surface 1050 may include additional components that may allow for vertical perching or parking modes of the aerial vehicle 530. For example, the landing surface 1050 may include supports that provide for vertical take-off and landing/perching of the aerial vehicle 530. In some examples, particularly when the aerial vehicle 530 is configured to perch when in a parked mode, the landing surface 1050 may be in a plane normal to a base surface, such as a ground surface. In other examples, the landing surface 1050 may be in a plane normal to the tower 1040

FIG. 11A and FIG. 11B depict an AWT 1100, according to another example embodiment. The AWT 1100 may take the form of, or be similar in form to, the AWT 500 and/or AWT 1000, except as indicated below. Similar to AWT 500, the AWT 1000 includes a gimbal assembly 510, a tether 520, and an aerial vehicle 530. These components of the AWT 1000 may have similar function as in the AWT 500. In FIG. 11A, the aerial vehicle 530 is depicted flying in a power generating flight mode similar to FIG. 5A, and in FIG. 11B, the aerial vehicle is shown in a parked configuration, similar to FIG. 10B. Power generating flight mode would function similarly in both AWT 500 and AWT 1000, and parked mode would function similar to AWT 1000.

As depicted in FIGS. 11A and 11B, the tower 1140 includes a landing surface 1180. The landing surface 1180 may be positioned at one of a first set of landing positions 1180A or a second set of landing positions 1180B. In other examples, a second landing surface may be positioned at another of the first set of landing positions 1180A or the second set of landing positions 1180B. The first set of landing positions 1180A may be at a first elevation above the surface 505, while the second set of landing positions 1180B may be at a second elevation above the surface 505.

In one embodiment, each set of landing positions 1180A and 1180B may include four individual landing positions that are evenly spaced out about the tower 1140. For example, the first set of landing positions 1180A may each be 90 degrees apart from each other around the circumference of the tower 1140. Similarly, the second set of landing positions 1180B may also be 90 degrees apart from each other. Moreover, each landing position of the first set of landing positions 1180A may be offset 45 degrees around the tower from each landing position of the second set of landing positions 1180B. In other embodiments, there may be more or less landing positions.

In some examples, when the aerial vehicle 530 lands on the landing surface 1180 (one of the landing positions 1180B as depicted in FIG. 11B), the tether 520 may include some slack that is allowed to droop below an elevation of the landing surface 1180 above a base surface. Within examples, at least a portion of the tether 520 may be below the landing surface 1180 when the aerial vehicle 530 is in a parked mode. In other words, at least a portion of the tether 520 may be at an elevation above the base surface 505 that is less than an elevation above the base surface 505 of the landing surface 1180 when the aerial vehicle 530 is in the parked mode. As such, a configuration of the tower 1140 with the landing surface 1180 may prevent the tether 520 from contacting the base surface without need for a complicated system to reel-in or pay-out the tether 520.

Other landing surface configurations are contemplated herein. For example, while the landing surface 1180 among the landing positions 1180A and 1180B is depicted as being horizontally planar, the landing surface 1180 may also include components to allow the aerial vehicle 530 to vertically perch on the landing surface 1180. As such, in some aspects, particularly wherein the aerial vehicle 530 perches when in the parked mode, the landing surface 1180 may be in a plane that is normal (or nearly normal) to the base surface.

### IV. CONCLUSION

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

We claim:

1. A system, comprising:
a tower extending upwards from a surface;
a gimbal assembly coupled to the tower above the surface, wherein the gimbal assembly is configured to move in multiple axes relative to the tower;
a ring coupled about the tower between the surface and the gimbal assembly, wherein the ring extends radially from the tower a first radial distance; and
an aerial vehicle configured for at least a power generating flight mode and a parked mode, wherein the aerial vehicle is coupled to the gimbal assembly via a tether, wherein in power generating flight mode the aerial vehicle flies downwind from the tower, wherein in parked mode the aerial vehicle hangs from the tether such that the tether supports the weight of the vehicle, and wherein in parked mode the ring is configured to contact the tether at a contact point along the tether.

2. The system of claim 1, wherein, when in parked mode, a first linear distance along a length of the tether from the contact point to a furthest end of the aerial vehicle from the tether is less than the first radial distance, such that the aerial vehicle is prevented from contacting the tower.

3. The system of claim 1, wherein during power generating flight mode the aerial vehicle flies between a minimum flight altitude and a maximum flight altitude.

4. The system of claim 3, wherein the gimbal assembly is located at an elevation above the surface between the minimum flight altitude and the maximum flight altitude

5. The system of claim 1, wherein the ring is coupled about the tower in a plane normal to the tower.

6. The system of claim 1, wherein the surface is a ground surface.

7. The system of claim 6, wherein the tower comprises: (i) a lattice structure, and (ii) a plurality of guy wires that are coupled between the lattice structure and the ground surface.

8. The system of claim 7, wherein the ring is coupled to the plurality of guy wires.

9. The system of claim 1, wherein the surface is a water surface.

10. The system of claim 9, wherein the tower is a floating buoy, and wherein the tower is configured to tilt in a direction of the aerial vehicle when the aerial vehicle is in the power generating flight mode.

11. The system of claim 10, wherein the tower is configured to tilt up to 50 degrees from vertical.

12. The system of claim 1, wherein the ring further comprises a coupling mechanism configured to couple the ring and tether together at the contact point.

13. The system of claim 1, wherein a plane formed by a closed flight path of the aerial vehicle is normal to the surface.

14. A system, comprising:
a tower extending upwards from a base surface;
a gimbal assembly coupled to the tower above the base surface, wherein the gimbal assembly is configured to move in multiple axes relative to the tower;
a first landing surface coupled to the tower between the base surface and the gimbal assembly, wherein the first landing surface extends radially from the tower a first radial distance; and
an aerial vehicle configured for at least a power generating flight mode and a parked mode, wherein the aerial vehicle is coupled to the gimbal assembly via a tether, wherein a first linear distance along a length of the tether from the gimbal assembly to a furthest end of the aerial vehicle from the tether is less than an elevation distance of the gimbal assembly above the base surface, such that the aerial vehicle is prevented from contacting the base surface, wherein in power generating flight mode the aerial vehicle flies downwind from the tower, and wherein in parked mode the aerial vehicle rests on the first landing surface.

15. The system of claim 14, wherein the first landing surface comprises an annular track that surrounds at least a portion of the tower.

16. The system of claim 14, wherein the system further comprises a second landing surface coupled to the tower between the base surface and the gimbal assembly, and wherein the second landing surface extends radially from the tower at a second radial distance.

17. The system of claim 16, wherein the first landing surface is coupled to the tower at a first distance along the tower from the gimbal, wherein the second landing surface is coupled to the tower at a second distance along the tower from the gimbal, and wherein the first distance along the tower is different than the second distance along the tower.

18. The system of claim 16, wherein the first landing surface is located about the tower at a first radial location, and wherein the second landing surface is located about the tower at a second radial location different than the first radial location.

19. The system of claim 14, wherein at least a portion of the tether is at an elevation above the base surface that is less than an elevation above the base surface of the first landing surface when the aerial vehicle is in the parked mode.

20. The system of claim 14, wherein the first landing surface is oriented in a plane normal to the base surface.
